(19) United States
(12) Patent Application Publication
(10) Pub. No.: US 2007/0035555 A1
(43) Pub. Date: Feb. 15, 2007

(54) DISPLAY DEVICE, METHOD OF CONTROLLING THE SAME, AND GAME MACHINE

(75) Inventors: Shinichi TSUKAGOSHI, Suwa-shi (JP); Yoshiyuki MORIYAMA, Suwa-shi (JP); Takayuki MIYAZAWA, Suwa-shi (JP)

Correspondence Address: OLIFF & BERRIDGE, PLC, P.O. BOX 19928, ALEXANDRIA, VA, 22320, US

(73) Assignee: SEIKO EPSON CORPORATION, Tokyo (JP)

(21) Appl. No.: 11/462,910

(22) Filed: Aug. 7, 2006

(30) Foreign Application Priority Data
Aug. 10, 2005 (JP) 2005-231698

(51) Int. Cl. G09G 5/02

(52) U.S. Cl. 345/589

(57) ABSTRACT

A display device includes: a display unit having an illuminating device that emits illumination light, a display panel that has an image display region where a two-dimensional image is formed by a light modulating device for modulating the illumination light, and a barrier that is arranged opposite to the image display region and performs switching between an operational state in which a three-dimensional image is displayed and a non-operational state in which the three-dimensional image is not displayed; and a control unit that adjusts illuminance of the illumination light incident on the display panel when the barrier is switched from the non-operational state to the operational state and/or when the barrier is switched from the operational state to the non-operational state.

### BACKGROUND

1. Technical Field

The present invention relates to a display device suitably incorporated into a game machine, such as a Japanese pinball game machine, a slot machine, or an arcade game machine, and more particularly, to a display device capable of performing three-dimensional display to a viewer, a method of controlling the display device, and a game machine including the display device.

2. Related Art

There has been proposed a three-dimensional display device in which a parallax barrier is arranged on the viewer side of a color liquid crystal panel, and a right-eye image line and a left-eye image line are alternately displayed on a display screen of the color liquid crystal panel (see JP-A-11-103475). In this case, a second color filter is provided between a backlight and the color liquid crystal display panel so as to be reversely arranged to a color filter of the color liquid crystal panel, thereby improving the color purity of the color liquid crystal panel.

There has been proposed another three-dimensional display device having the following structure: images of a three-dimensional object captured by four cameras or equivalent images thereof are divided into sub-pixels, the sub-pixels are arranged on a flat panel display so as to correspond to the four cameras; and the image on the flat panel display is viewed to a viewer through a step barrier (‘Step barrier system multi-view glass-less 3-D display’, SPIE-IS & T, Volume 5291, pp 265 to 272, 2004).

Further, there has been proposed a game machine having the following structure: when a game ball gets into a starting hole, for example, numbers are variably displayed on a display device arranged at the center of a pinball game disk; and when the same numbers appear in the display device, you hit the jackpot, and then corresponding prizewinning balls are discharged from the game machine. A display device for this type of game machine includes, for example, a pair of light sources, a pair of polarizing filters corresponding to the light sources, a Fresnel lens, a minute retardation plate, a first polarizing plate, a liquid crystal display panel, and a second polarizing plate that are sequentially arranged along an optical path (see JP-A-2005-52200). In this display device, a combination of a right-eye image and a left-eye image is formed on the liquid crystal display panel so as to correspond to a pattern of the minute retardation plate, and a three-dimensional projection amount of an image is set by the difference between the positions of pixels of the right-eye image and the left-eye image.

Furthermore, there has been proposed another game machine that has a three-dimensional display device using a lenticular lens provided therein and provides a three-dimensional game image to a gamer by a binocular parallax method (see JP-A-7-16351). In the three-dimensional display device, after a predetermined time has elapsed, the binocular parallax is removed to cause a three-dimensional image to be switched to a two-dimensional image. In this way, it is possible to prevent the eye strain of a gamer when the gamer views a three-dimensional game image for a long time.

Further, there has been proposed still another game machine that has a three-dimensional display device including image splitters are alternately provided in transmissive portions and light-shielding portions and provides a three-dimensional game image to a gamer by the binocular parallax method (see JP-A-9-164263). The three-dimensional display device includes a left-eye image signal switching circuit and a right-eye image signal switching circuit and performs switching between a two-dimensional image and a three-dimensional image according to instructions from a display CPU.

However, the three-dimensional display devices (JP-A-11-103475 and ‘Step barrier system multi-view glass-less 3-D display’) do not disclose switching between a three-dimensional image and a two-dimensional image and various display methods using the switching between the three-dimensional image and the two-dimensional image.

In the game machines for three-dimensional display (JP-A-2005-52200, JP-A-7-16351, and JP-A-9-164263), since the switching between the two-dimensional image and the three-dimensional image is performed according to whether to give parallax to both eyes, the visual brightness of the two-dimensional image is equal to that of the three-dimensional image. However, the lenticular lens or the image splitter makes it difficult to view the two-dimensional image. In particular, when the image splitter is used, even in the two-dimensional image display, the image splitter continuously shield light, and thus light is not effectively used.

### SUMMARY

An advantage of some aspects of the invention is that it provides a display device capable of smoothly switching the visual brightness of a displayed image at the time of switching between a three-dimensional image and a two-dimensional image, while displaying a two-dimensional image that has high brightness and is easy to view, a method of controlling the display device, and a game machine provided with the display device.

According to an aspect of the invention, a display device includes: (a) a display unit having an illuminating device that emits illumination light, a display panel that has an image display region where a two-dimensional image is formed by a light modulating device for modulating the illumination light, and a barrier that is arranged opposite to the image display region and performs switching between an operational state in which a three-dimensional image is displayed and a non-operational state in which the three-dimensional image is not displayed; and (b) a control unit that adjusts illuminance of the illumination light incident on the display panel when the barrier is switched from the non-operational state to the operational state and/or when the barrier is switched from the operational state to the non-operational state.

In the display device, since the display unit includes the barrier that can be switched between the operational sate and the non-operational state, it is easy to view a two-dimensional image in the non-operational state, and it is possible to reduce the shielding of light in the operational state. In addition, in the display device, when the control unit switches the barrier from the non-operational state to the operational state or from the operational state to the non-operational state, the illuminance of illumination light incident on the display panel is adjusted. Therefore, it is possible to control the visual brightness so that a viewer hardly perceives a variation in the visual brightness occurring at the time of switching between the operational state and the non-operational state. The term ‘visual brightness’ means the brightness of the image of the display device viewed by the viewer.

In the display device according to this aspect, preferably, when the barrier is switched from the non-operational state to the operational state, the control unit increases the illuminance of the illumination light incident on the display panel. According to this structure, the barrier is switched to the operational state, and thus it is possible to increase the display brightness of the display panel so as to compensate for a drop in visual brightness. Therefore, when the barrier is switched from the non-operational state to the operational state, it is possible to prevent a large variation in the visual brightness and thus to reduce the eye strain of a viewer.

In the display device according to this aspect, preferably, when the barrier is switched from the operational state to the non-operational state, the control unit decreases the illuminance of the illumination light incident on the display panel. According to this structure, when the barrier is switched from the operational state to the non-operational state, it is possible to prevent a large variation n the visual brightness and thus to reduce the eye strain of a viewer.

In the display device according to this aspect, preferably, the illuminating device increases or decreases the illuminance of the illumination light according to an adjustment signal from the control unit, and the barrier switches the state thereof according to a switching signal from the control unit. In addition, preferably, the control unit sets a predetermined time interval between a first timing when the adjustment signal is output and a second timing when the switching signal is output. According to this structure, it is possible to individually control the barrier and the illuminating device, and thus to arbitrarily set the timing of an increase/decrease in the illuminance of illumination light and the operation of the barrier.

In the display device according to this aspect, preferably, the predetermined time interval is set considering at least a response characteristic of the illuminating device with respect to the switching signal, and the response characteristic varies with time. According to this structure, even when the response speed of the illuminating device is delayed by, for example, the barrier, it is possible to prevent a time difference between an increase/decrease in the illuminance of illumination light and the operation of the barrier, and thus to prevent an unnatural image from being displayed at the time of switching between the three-dimensional image and the two-dimensional image.

In the display device according to this aspect, preferably, the control unit switches the barrier from the non-operational state to the operational state step by step or continuously. According to this structure, it is possible to perform smooth switching between the three-dimensional image and the two-dimensional, and thus to reduce the eye strain of a viewer. In particular, when an increase/decrease in the illuminance of illumination light slightly varies at the time of switching, it is possible to slightly vary the state of the barrier between non-operational state and the operational state so as to correspond to the variation.

According to another aspect of the invention, a game machine includes: (a) the above-mentioned display device that performs three-dimensional display in at least a portion of the image display region; and (b) an effect control unit that performs the three-dimensional display on the display device according to the progress of a game. The effect control unit can perform a variable display game allowing the display device to variably display identification information, and can generate a special game state for giving a specific game value in connection with the result of the variable display game.

The game machine is provided with the above-mentioned display device, and switching between two-dimensional display and three-dimensional display is performed without any incongruity according to the progress of a game in the display device. Therefore, it is possible for a gamer to enjoy a very exciting game by image display without eye strain.

According to still another aspect of the invention, a method of controlling a display device includes: switching a barrier that is arranged opposite to an image display region where a two-dimensional image is formed by a light modulating device for modulating illumination light between an operational state in which a three-dimensional image is displayed and a non-operational state in which the three-dimensional image is not displayed, an image display region; and adjusting illuminance of the illumination light incident on a display panel when the barrier is switched from the non-operational state to the operational state and/or when the barrier is switched from the operational state to the non-operational state.

According to the control method, the barrier can be switched between the operational state and the non-operational state, a viewer can easily see the two-dimensional image in the non-operational state, and it is possible to reduce the shielding of light existing in the operational state. In additions in the control method, when the barrier is switched from the non-operational state to the operational state or from the operational state to the non-operational state, it is possible to adjust the illuminance of illumination light incident on the display panel. Therefore, it is possible to reduce a variation in the visual brightness occurring at the time of switching between the operational state and the non-operational state so that a viewer cannot recognize the variation.

The control method according to the above-mentioned aspect controls the above-mentioned display device. That is, according to the control method according to this aspect, the illuminance of illumination light incident on the display panel is adjusted when the barrier is switched from the non-operational state to the operational state and/or when the barrier is switched from the operational state to the non-operational state.

### BRIEF DESCRIPTION OF THE DRAWINGS

The invention will be described with reference to the accompanying drawings, wherein like numbers reference like elements.

FIG. 1 is a front view illustrating the overall structure of ea game machine according to a first embodiment of the invention.

FIG. 2 is a block diagram illustrating a control system of the game machine shown in FIG. 1.

FIG. 3 is a cross-sectional view illustrating the structure of an image display device.

FIGS. 4A to 4E are enlarged views illustrating an example of the arrangement of display pixels of a liquid crystal display device.

FIG. 5 is a diagram illustrating an example of the display of the image display device.

FIG. 6 is a flow chart Illustrating an example of the operation of the image display device.

FIG. 7 is a graph illustrating the adjustment of illumination light by the operation shown in FIG. 6.

FIG. 8 is a flow chart illustrating another example of the operation of the image display device.

FIG. 9 is a graph illustrating the adjustment of illumination light by the operation shown in FIG. 8.

FIGS. 10A and 10B are flow charts illustrating examples of the operation of a display device assembled into a game machine according to a second embodiment.

FIGS. 11A and 11B are graphs illustrating the adjustment of illumination light by the operations shown in FIGS. 10A and 10B.

### DESCRIPTION OF EXEMPLARY EMBODIMENTS

### First Embodiment

Hereinafter, a game machine according to a first embodiment of the invention will be described in detail with reference to the accompanying drawings.

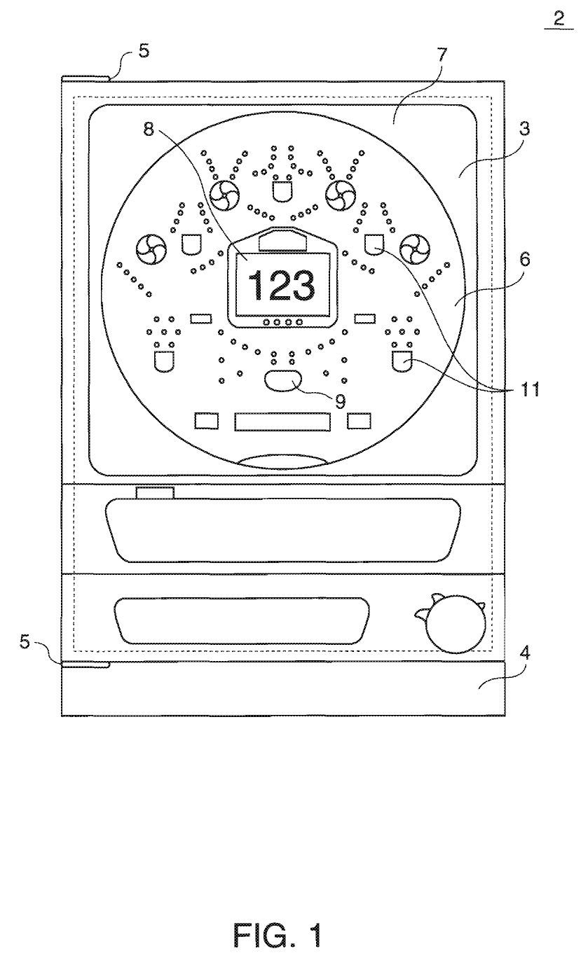

FIG. 1 is a front view illustrating the game machine according to the first embodiment. A game machine 2 shown in FIG. 1 is a Japanese pinball game machine, and includes a front frame 3, a main frame 4, and a game board 6. The front frame 3 is openably mounted to the external main frame 4 through a hinge 5. The game board 6 is housed in a housing frame. The housing frame is mounted to the rear surface of the front frame 3. A cover glass 7 covering the front surface of the game board 6 is mounted to the front frame 3.

A game area surrounded by a guide rail is formed on the surface of the game board 6, and an image display device 8, which is a special pattern display device, is provided substantially at the center of the game area. The image display device 8 can display a left-eye image component and a right-eye image component at different places such that the image components do not overlap each other, and can display a three-dimensional binocular image by means of binocular parallax using a barrier. For example, on the game board 6, a plurality of winning holes 11 are arranged in the periphery of the image display device 8 provided at the center of the game area.

The image display device 8 serves as a display unit and includes a display screen formed by an LCD (liquid crystal display), that is, an image display region. A plurality of variable display regions are provided in an area capable of displaying an image of the display screen. An image including identification information (a special pattern and a general pattern) or a character producing a variable display game is displayed in each of the variable display regions. That is, patterns allocated as identification information (for example, fourteen types of patterns including numbers from ‘0’ to ‘9’ and characters from ‘A’ to ‘D’) are variably displayed in the variable display regions provided at the left, center, and right of the display screen, and thus a variable display game is played. In addition, an image corresponding to the progress of the game is displayed on the display screen on the basis of the progress of the game.

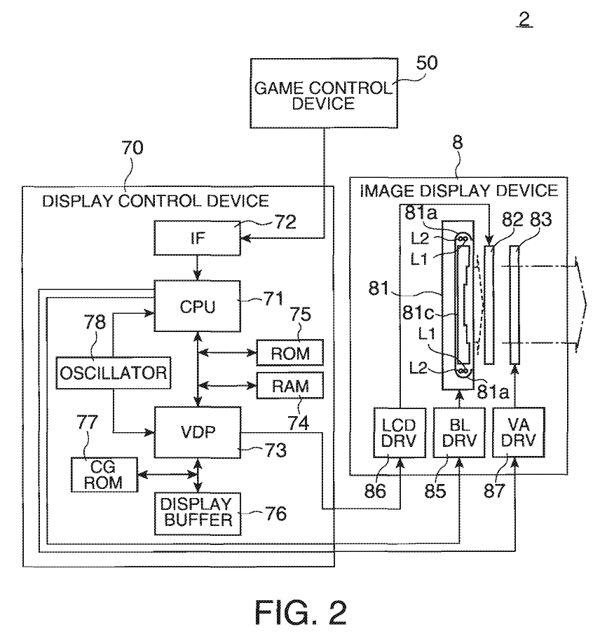

FIG. 2 is a block diagram illustrating a portion of a game system related to the basic operation of the game machine 2 shown in FIG. 1.

A game control device 50 is a main control device for generally controlling the game, and corresponds to an effect control unit in the embodiment according to the invention.

A display control device 70 processes and operates image control Information (for example, pattern display information, background screen information, three-dimensional display images) for the variable display game according to instructions from the game control device 50 and appropriately operates the image display device 8. As shown in FIG. 2, the display control device 70 includes a CPU 71, an input interface 72, a video processor 73, a work RAM 74, a program ROM 75, a display buffer 76, a CGROM 77, and an oscillator 78. The display control device 70 is composed of a two-dimensional image processing circuit, and can display or move a two-dimensional or three-dimensional image, such as a character or a selected pattern on a background image, thereby performing display control. The CPU 71 serves as a control unit that uses three-dimensional image data as a group of two-dimensional display data to control the operational state of the image display device 8. The video processor 73 and the display buffer 76 serve as a two-dimensional image processing circuit for driving the image display device 8 together with an LCD driving device 86, which will be described later. The CGROM 77 functions as a storage unit that stores three-dimensional image data beforehand and supplies the data to, for example, the video processor 73. The program ROM 75 stores invariable information for operating the display control device 70, and the work RAM 74 is used as a work area at the time of display control according to instructions from the game control device 50.

The image display device 8 is a display unit that performs display related to the progress of the game including, for example, the variable display game, and includes an illuminating device 81, a display panel 82, and an LCD barrier 83. The illuminating device 81 uniformly illuminates the display region of the display panel 82 from the rear side. The display panel 82 can modulate illumination light to form a desired color image. The LCD barrier 83 is a mask with a fine and periodic pattern capable of shielding the display panel 82 and can convert an image formed on the display panel 82 into a four-dot or two-dot three-dimensional image in cooperation with the display panel 82. The illuminating device 81 includes a pair of lamp light sources 82a for emitting substantially white light and an light guide 82c that makes light from each of the lamp light sources 82a uniform and emits the uniform light to the rectangular display panel 82. The lamp light sources 82a include two lamps L1 and L2 that are individually turned on or off. The lamps L1 and L2 are composed of, for example, cold-cathode tubes, hot-cathode tubes, or LEDs. The illuminating device 81 is driven by a backlight driving device 85 under the control of the CPU 71 of the display control device 70 and can be appropriately switched to an OFF state in which both the lamps L1 and L2 are turned off, a low-illuminance state in which only the lamp L1 is turned on, or a high-illuminance state in which both the lamps L1 and L2 are turned on. The illuminating device 81 emits uniform and low-illuminance light in the low-illuminance state, but emits uniform and high-illuminance light in the high-illuminance state. The display panel 82 illuminated by the illuminating device 81, serving as a light modulating device, is driven by the LCD driving device 86 under the control of the video processor 73 of the display control device 70, and modulates illumination light to form a color transmissive image. The LCD barrier 83 is driven by a barrier driving device 87 under the control of the CPU 71 of the display control device 70 to be turned on or off and performs switching between two-dimensional display (that is, normal display) and three-dimensional display (that is, stereoscopic display).

In the above-mentioned structure, the image display device 8 and the display control device 70 form a display device capable of displaying a three-dimensional moving picture related to the progress of the game.

Hereinafter, the general operation of the game machine 2 shown in FIGS. 1 and 2 will be described. In the game machine 2, a game starts by shooting a game ball to the game area by a ball shooting device (not shown), and then the game ball moves down in the game area.

When the game ball gets into a starting hole 9, the game control device 50 draws lots, and a command indicating display content is output to the display control device 70. The image display device 8 receives the command and displays a predetermined image. As the result of the lot, when a gamer draws a prize, three similar display patterns (prizewinning patterns) appear.

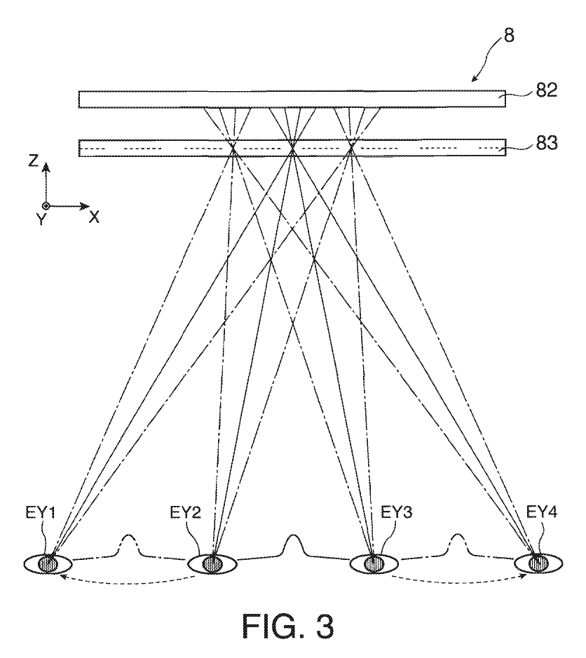

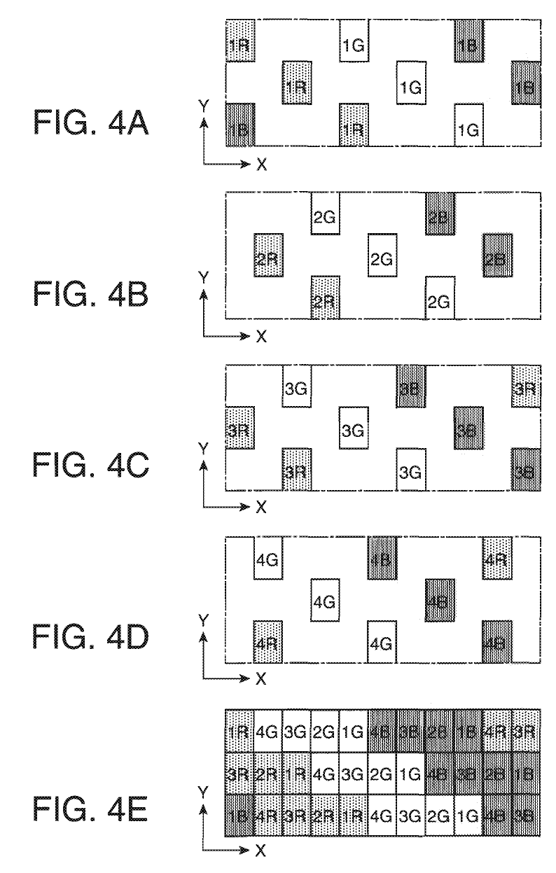

The image display device 8 can display a three-dimensional image by the operation of the LCD barrier 83, as described above. When the LCD barrier 83 is turned off (normal display mode), it is possible to see all pixels. On the other hand, when the LCD barrier 83 turned on (three-dimensional display model) as a viewpoint moves as shown in FIG. 3, it is possible to see only the pixels corresponding to the individual viewpoints, as shown in FIGS. 4A to 4D. Therefore, it is possible for a gamer to see different images with left and right eyes and thus to perform a three-dimensional display.

FIGS. 4A to 4E show examples of the arrangement of display pixels in a liquid crystal display unit forming the display panel 82. FIG. 4A shows an example of the arrangement of display pixels kR, kG, and kB (k is a viewpoint number) corresponding to a first eye EY1 of FIG. 3. FIG. 4B shows an example of the arrangement of the display pixels kR, kG, and kB corresponding to a second eye EY2 of FIG. 3. FIG. 4C shows an example of the arrangement of the display pixels kR, kG, and kB corresponding to a third eye EY3 of FIG. 3. FIG. 4D shows an example of the arrangement of the display pixels kR, kG, and kB corresponding to a fourth eye EY4 of FIG. 3. It is possible to form a three-dimensional image (a composite image) by combining first to fourth images shown in FIGS. 4A to 4D (see FIG. 4E). Such a three-dimensional image corresponds to one frame of images displayed by the image display device 8 or a portion of the frame of images. When a target three-dimensional image corresponds to one frame of images, data corresponding to one frame of three-dimensional images (a group of two-dimensional display data shown in FIG. 4E) is temporarily stored in the display buffer 76 provided in the display control device 70 shown in FIG. 2 and the stored three-dimensional image data is output to the display panel 82 through the LCD driving device 86. In this way, the gamer can see a composite three-dimensional image corresponding to the three-dimensional image data stored in the display buffer 76 through the LCD barrier 83 in an ON state and thus can recognize a three-dimensional image on the display panel 82.

When a three-dimensional image composed of a plurality of frames continuously varying is stored in the CGROM 77 of the display control device 70 shown in FIG. 2 for every frame, it is also possible to display a three-dimensional moving picture on the display panel 82. On the other hand, in a case in which a target three-dimensional image corresponds to a portion of one frame of images, when partial image data (a group of two-dimensional display data shown in FIG. 4E) continuously varying is stored in the CGROM 77 as a series of three-dimensional images, it is also possible to display a three-dimensional moving picture of the partial image on the display panel 82 by rewriting of data related to the partial image. In this case; since only the two-dimensional image is stored in the CGROM 77 in the unit of frames or as a partial image, it is possible to generate image data to be stored in the display buffer 76 by the simple read of the two-dimensional image or the superimposition of images. That is, three-dimensional data processing using, for example, a polygon does not need to be performed in the display control device 70. Even when the processing speed of the video processor 73 is relatively delayed, it is possible to display a moving picture with a sufficiently high resolution and at a high frame rate.

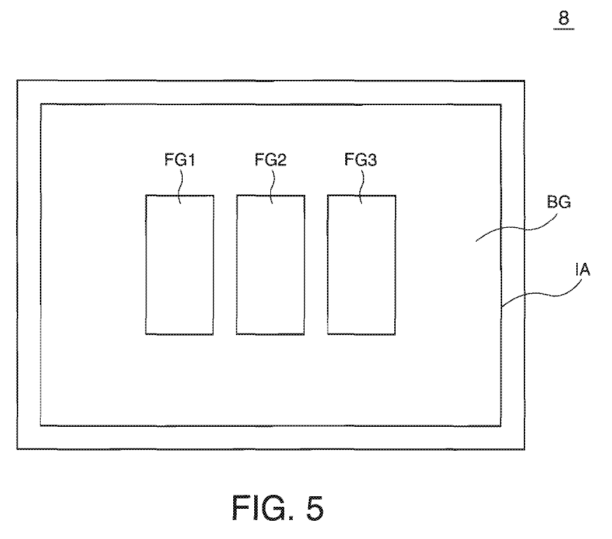

FIG. 5 shows an example of the display of a three-dimensional image by the image display device 8. In this case, a background image BG is displayed in a peripheral portion of an image display region IA of the image display device 8, and three foreground images FG1 to FG3 are displayed in a line at the center of the image display region IA.

The background image BG is generally a static or plain image, and may be an image including, for example, a character. In this case, the background image BG is a two-dimensional image, and image data for allowing a two-dimensional image to be viewed through the LCD barrier 83 that is an ON state is prepared. The image data for two-dimensional display may be previously computed by an external computer and be then stored in the CGROM 77 of the display control device 70 shown in FIG. 2 as two-dimensional image data. In order to exactly display an image, two-dimensional image data to be viewed through the LCD barrier 83 that is in an OFF state is thinned out to, for example, a quarter, and is then converted such that the same image is viewed from all viewpoints through the LCD barrier 83. However, practically, preparing an image corresponding to a normal display (two-dimensional display) state is enough for image display. The background image BG is not limited to a still picture, but it may be a moving picture. In this case, for example, image data corresponding to each frame forming a moving picture is stored in the CGROM 77.

The foreground images FG1 to FG3 are composed of variable display regions of a variable display game, that is, a reach. That is, a three-digit pattern allocated as identification information is displayed in the foreground images FG1 to FG3. In this case, the foreground images FG1 to FG3 make it possible to display a three-dimensional moving picture, and are stored in the CGROM 77 of the display control device 70 shown in FIG. 2 as partial images. Each of the foreground images FG1 to FG3 is composed of a series of three-dimensional image data that is arranged in time series. The three-dimensional image data individually realize four-viewpoint three-dimensional images, corresponding to a combined image (a composite image for three-dimensional display) of the images viewed along the four viewpoints shown in FIG. 4E. That is, it is possible to dynamically display a desired three-dimensional image at a desired timing by controlling the timing when a series of three-dimensional image data forming each of the foreground images FG1 to FG3 is read out from the CGROM 77 to the display buffer 76. For example, an external high-speed computer performs three-dimensional image processing to compute the three-dimensional image data. More specifically, for example, an image of an object approximately obtained by a polygon or texture mapping is viewed from four viewpoints corresponding to EY1 to EY4 of FIG. 3, and then rendering (image processing) is performed on the individual images viewed from the four viewpoints. At that time, processes required for production or effects are additionally performed. An image that is time-serially changed at every viewpoint is computed as moving picture data by repeatedly performing the computation while deforming, for example, a polygon. The moving picture data at each viewpoint is allocated as shown in FIGS. 4A to 4D, and is combined as shown in FIG. 4E. Then, the combined moving picture data is converted into three-dimensional image data for frames of moving pictures, and the converted three-dimensional image data is transmitted to the C&ROM 77 and is then stored therein.

Next, the outline of the operation of, for example, the image display device 8 shown in FIG. 2 will be described. The CPU 71 of the display control device 70 receives a display control command from the game control device 50 through the input interface unit 72. Then, the CPU 71 outputs suitable commands to the illuminating device 81, the display panel 82, and LCD barrier 83 or the like, on the basis of the content of the received display command, and adjusts the operation and operational timing of, for example, the display panel 82 and the LCD barrier 83. More specifically, the CPU 71 supplies to the backlight driving device 87 a signal (adjustment signal) for setting the mode of the illuminating device 81 to the low-illuminance state in which the lamp L1 of the illuminating device 81 is turned on or the high-illuminance state in which both the lamps L1 and L2 are turned on, according to whether a display image instructed by the game control device 50 is a two-dimensional image or a three-dimensional image. In addition, the CPU 71 supplies a signal (switching signal) for turning on or off the LCD barrier 83 to the barrier driving device 87, according to whether the display image instructed by the game control device 50 is a two-dimensional image or a three-dimensional image. The video processor 73 sequentially reads out the display image corresponding to the instruction of the CPU 71 from the CGROM 77 and transmits the read display image to the display buffer 76. A two-dimensional image or a three-dimensional image combined by overlay by means of two-dimensional image processing in the display buffer 76 is output from the video processor 73 to the LCD driving device 86, and a two-dimensional moving picture or a three-dimensional moving picture corresponding to the image stored in the display buffer 76 is displayed on the display panel 82. In this case, since the three-dimensional image data previously stored in the CGROM 77 is read out and is just two-dimensionally combined, high-speed processing is not needed, and it is possible to provide the inexpensive display control device 70 capable of displaying high-resolution three-dimensional moving pictures.

In the image display device 8, the LCD barrier 83 is turned off in a two-dimensional display mode for displaying a two-dimensional image, and the LCD barrier 83 is turned on in a three-dimensional display mode for displaying a three-dimensional image. Therefore, assuming that illumination light having uniform brightness is emitted from the illuminating device 81, in a game mode in which a two-dimensional image is displayed on the image display device 8, the gamer can see the display panel 82 through the LCD barrier 83 that is substantially transparent. That is, the gamer sees two-dimensional image without any obstacle interposed therebetween, and the brightness of the image is not lowered. In addition, there is no restriction on the viewpoint of the image due to the LCD barrier 83. Therefore, the gamer loses an interest in the game a little from the visual viewpoint, but can concentrate on the game with a relatively small visual load. On the other hand, in a game mode in which a three-dimensional image is displayed on the image display device 8, the gamer can see the display panel 82 through the transparent LCD barrier 83 that is turned on. That is, the brightness of the three-dimensional image is relatively lowered due to a kind of obstacle, and it is difficult for the gamer not accustomed to a three-dimensional image to enjoy the three-dimensional image without any difficulty. Therefore, the visual load of the gamer increases. However, when three-dimensional display is performed at the timing when the game reaches its most exciting point, the gamer can enjoy the game with realistic visual effects.

Here, switching from a two-dimensional image to a three-dimensional is considered. When the LCD barrier 83 is switched from an OFF state to an ON state to cause switching from the two-dimensional image to the three-dimensional image, assuming that illumination light with uniform brightness is emitted from the illuminating device 81, the visual brightness of the image is remarkably lowered. In particular, when the LCD barrier 83 of the image display device 8 according to this embodiment enabling viewers to see three-dimensional images at four viewpoints is turned on, the display brightness of the image display device 8 is lowered to a quarter of the theoretical value of brightness. Therefore, incongruity is likely to occur in the switching from the two-dimensional image to the three-dimensional image, and it takes a lot of time to adapt to a dark image. Therefore, the gamer may temporarily lose an interest in the game.

In contrast, when the LCD barrier 83 is switched from an ON state to an OFF state to cause switching from the three-dimensional image to the two-dimensional image, assuming that illumination light with uniform brightness is emitted from the illuminating device 81, the visual brightness of the image remarkably rises. In particular, when the LCD barrier 83 of the image display device 8 according to this embodiment enabling viewers to see three-dimensional images at four viewpoints is turned off, the display brightness of the image display device 8 rises four times larger than the theoretical value of brightness. Therefore, incongruity is likely to occur in the switching from the three-dimensional image to the two-dimensional image, and it takes a lot of time to adapt to a bright image. The gamer may temporarily lose an interest in the game. However, when the three-dimensional image is switched to the two-dimensional image, the visual brightness of the image rises, and the gamer's eye is likely to follow the two-dimensional image. Therefore, little incongruity occurs, as compared with the case in which the brightness of the image is lowered by the switching from the two-dimensional image to the three-dimensional image.

Accordingly, when the LCD barrier 83 is turned on or off, a variation in the visual brightness of an images, that is, the brightness of an image sensed by the viewer of the display device, is reduced. That is, in the two-dimensional image display mode in which the LCD barrier 83 is turned off, the illuminating device 81 in the low-illuminance state illuminates the display panel 82 with relatively low brightness. On the other hand, in the three-dimensional image display mode in which the LCD barrier 83 is turned on, the illuminating device 81 in the high-illuminance state illuminates the display panel 82 with relatively high brightness. In addition, it is possible to reduce visual incongruity when the two-dimensional image is switched to the three-dimensional image by matching the timing of the switching between the ON state and the OFF state of the LCD barrier 83 with the timing of the switching between the low-illuminance state and the high-illuminance state of the illuminating device 81.

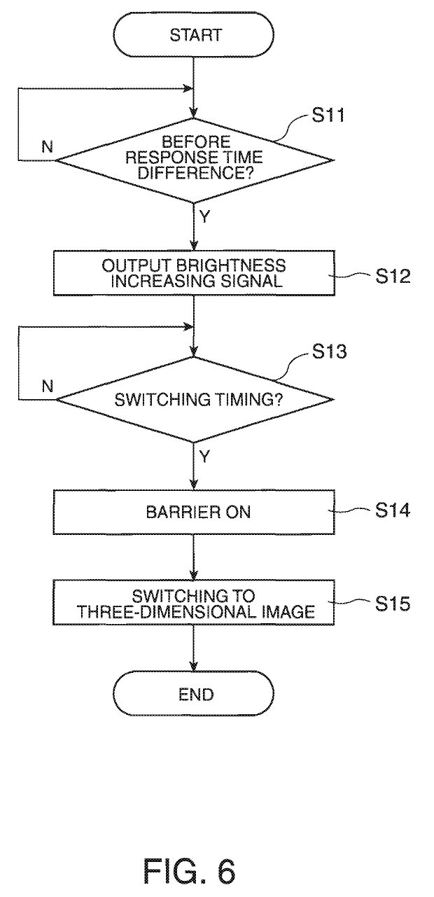

FIG. 6 is a flow chart illustrating the control of the brightness of illumination light when the two-dimensional image is switched to the three-dimensional image. The flow chart shown in FIG. 6 and flow charts, which will be described later, are just illustrative, and set values and parameters related to the operation of components can be appropriately changed according to the operational conditions.

First, the image display device 8 operates in the two-dimensional image display mode. That is, the CPU 71 of the display control device 70 appropriately operates the video processor 73 with the LCD barrier 83 of the image display device 8 turned off, sequentially reads out two-dimensional image data from the CGROM 77, and controls the display panel 82 to display a two-dimensional image. At that time, the LCD barrier 83 is turned off to improve transmittance, the illuminating device 81 is in the low-illuminance state, and the display panel 82 is illuminated by light with relatively low brightness. When the switching from the two-dimensional image to the three-dimensional image is performed, the CPU 71 determines whether an exact display switching timing is before ‘response time difference’ (step S11). The term ‘response time difference’ means a response time required until the brightness of the illuminating device 81 rises corresponding to an adjustment signal which is output from the CPU 71 to the illuminating device 81 through the backlight driving device 87, and also means a time required until an output is switched from the low-illuminance state to the high-illuminance state in response to the adjustment signal. More specifically, when the second lamp L2 is turned on with the first lamp L1 turned on in the illuminating device 81, the response characteristic of the second lamp L2 with time causes the brightness of the second lamp L2 to rise with a time delay of about 0.5 second from the timing when the adjustment signal of the CPU 71 is switched to a high level. Only the response characteristic of the second lamp L2 with time is considered above. However, here, it is considered that the LCD barrier 83 has a relatively high response characteristic, and the response delay of the LCD barrier 83 with respect to a switching signal (several to ten milliseconds) is considerably smaller than the response delay of the second lamp L2 with respect to the switching signal so that the response delay of the LCD barrier 83 with respect to a switching signal can be neglected. When the response delay of the LCD barrier 83 is very large so that it cannot be neglected, the difference between the response delay time of the illuminating device 81 and the response delay time of the LCD barrier 83 is considered as the ‘response time difference’. In this case, it is possible to match these operational timings by processing the difference between the response time of the liquid crystal panel 82 and the response delay time of the illuminating device 81 or the LCD barrier 83. In step S11, when it is determined that it is as earlier as the response time difference than the display switching timing, the CPU 71 outputs to the illminating device 81 the adjustment signal for switching the illuminating device 81 from the low-illuminance state to the high-illuminance state through the backlight driving device 87 (step S12). Then, the CPU 71 determines whether now is the display switching timing from a two-dimensional image to a three-dimensional image (step S13). When it is determined that now is the display switching timing, the CPU 71 controls the LCD barrier 83 of the image display device 8 to be switched to an ON state (step S14), appropriately operates the video processor 73 to sequentially read out the three-dimensional image data from the CGROM 77, and controls the display panel 82 to display a three-dimensional image instead of a two-dimensional image (step S15).

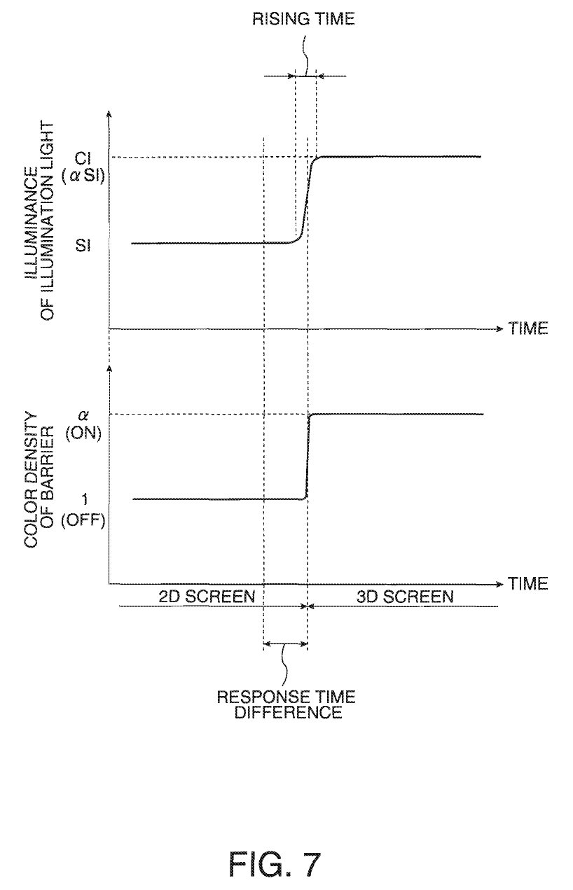

FIG. 7 is a graph illustrating the adjustment of illumination light when the two-dimensional image is switched to the three-dimensional image. As can be apparently seen from the graph, during a response period and after the response period, the illuminance of illumination light gradually increases from a low-illuminance value SI in the two-dimensional image display mode to a high-illuminance value CI in the three-dimensional image display mode. The illuminance of illumination light increases a times corresponding to an increasing rate a of the color density of the LCD barrier 83 after the switching. However, since the LCD barrier 83 operates to be in a semi-transmissive state, the brightness of an image viewed by the gamer is kept at a constant level.

The increasing rate α of the color density by the operation of the LCD barrier 83 depends on the type and driving method of the LCD barrier 83. Therefore, the increasing rate α can be changed according to the operational characteristics of the LCD barrier 83 or the display panel 82.

As can be seen from the graph shown in FIG. 7, the illuminance of illumination light emitted from the illuminating device 81 gradually increases and the switching of the illuminating device 81 from the low-illuminance state to the high-illuminance state is unclear. Therefore, a point of time when the illuminance of illumination light emitted from the illuminating device 81 is at half the high level is approximated to a switching time when the low-illuminance state is switched to the high-illuminance state, and the difference between the response times of the illuminating device 81 and the LCD barrier 83 is set using the switching point. However, a point of time when the illuminance of illumination light starts to rise or it is at the high level can be used as the switching time.

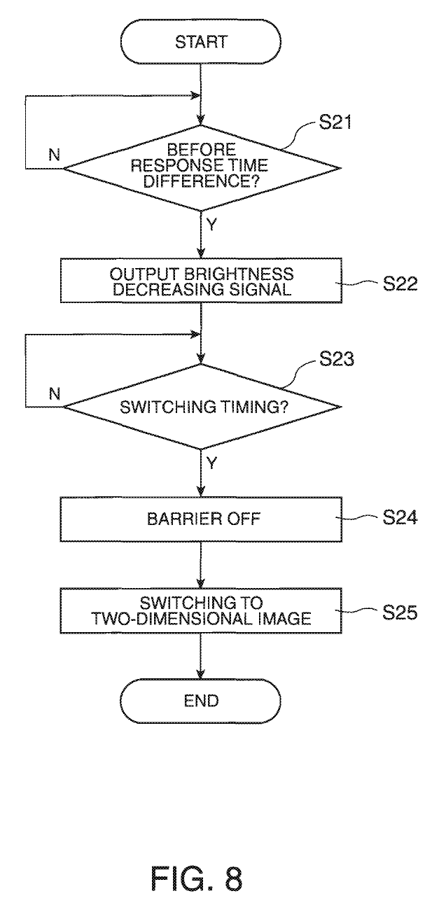

FIG. 8 is a flow chart illustrating the control of the illuminance of illumination light when the three-dimensional image is switched to the two-dimensional image. First, the image display device 8 operates in the three-dimensional image display mode. That is, the CPU 71 of the display control device 70 appropriately operates the video processor 73 with the LCD barrier 83 of the image display device 8 turned on, sequentially reads out three-dimensional image data from the CGROM 77, and controls the display panel 82 to display a three-dimensional image. At that time, the LCD barrier 83 is turned on to lower transmittance, the illuminating device 81 s switched to the high-illuminance state, and the display panel 82 is illuminated by light with relatively high brightness. When the switching from the three-dimensional image to the two-dimensional image is performed, the CPU 71 determines whether it is as earlier as ‘response time difference’ than an exact display switching timing (step S21). The term ‘response time difference’ means a response time required until the brightness of the illuminating device 81 is lowered corresponding to an adjustment signal that is output from the CPU 71 to the illuminating device 81 through the backlight driving device 87, and also means a time required until an output is switched from the high-illuminance state to the low-illuminance state in response to the adjustment signal. More specifically, When the state in which the two lamps L1 and L2 are turned on is switched to the state in which the second lamp L2 is turned off, the response characteristic of the second lamp L2 with time causes the brightness of the second lamp L2 to be lowered with a time delay of, for example, about 0.2 second from the timing when the adjustment signal from the CPU 71 is switched to a high level. Only the response characteristic of the second lamp L2 with time is considered above. However, in general, it is considered that the LCD barrier 83 has a relatively high response characteristic, and the response delay of the LCD barrier 83 with respect to a switching signal is very small so that it can be neglected. When the response delay of the LCD barrier 83 is very large so that it cannot be neglected, the difference between the response delay time of the illuminating device 81 and the response delay time of the LCD barrier 83 is considered as the ‘response time difference’. In this case, it is possible to match these operational timings by processing the difference between the response time of the liquid crystal panel 82 and the response delay time of the illuminating device 81 or the LCD barrier 83. When it is determined that it is as earlier as the response time difference than the display switching timing, the CPU 71 outputs to the illuminating device 81 the adjustment signal for switching the illuminating device 81 from the high-illuminance state to the low-illuminance state through the backlight driving device 87 (step S22). Then, the CPU 71 determines whether now is the display switching timing from a three-dimensional image to a two-dimensional image (step S23). When it is determined that now is the display switching timing, the CPU 71 controls the LCD barrier 83 of the image display device 8 to be switched to an OFF state (step S24), appropriately operates the video processor 73 to sequentially read out the two-dimensional image data from the CGROM 77, and controls the display panel 82 to display a two-dimensional image instead of a three-dimensional image (step S25).

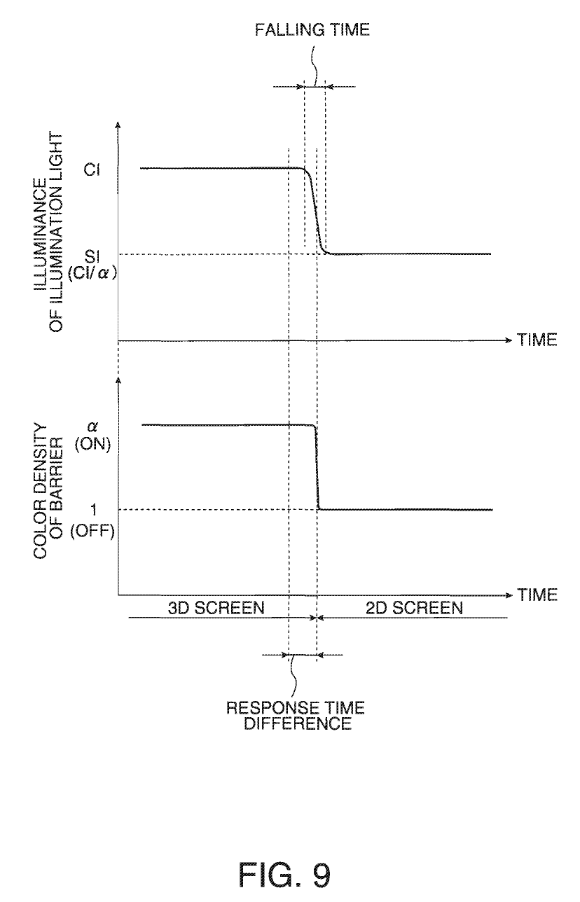

FIG. 9 is a graph illustrating the adjustment of illumination light when the three-dimensional image is switched to the two-dimensional image. As can be apparently seen from the graph, during a response period and after the response period, the illuminance of illumination light gradually decreases from the high-illuminance value CI in the three-dimensional image display mode to the low-illuminance value SI in the two-dimensional image display mode. The illuminance of illumination light is lowered 1/α times corresponding to a decreasing rate 1/α of the color density of the LCD barrier 83 after the switching. However, since the operation of the LCD barrier 83 ends to raise transmittance, the brightness of an image viewed by the gamer is kept at a constant level.

In the first embodiment, it is unnecessary to make a variation CI/SI in the illuminance of illumination light exactly equal to a variation α in the color density of the LCD barrier 83. However, when the variations are equal to each other, a variation in the visual brightness is reduced, and the incongruity of the gamer with respect to a three-dimensional image is reduced, which makes it possible to prevent troubles, such as eyestrain. In addition, in order to effectively operate the display panel 82, when the two-dimensional image is switched from the three-dimensional image. It is desirable to lower the visual brightness a little.

### Second Embodiment

Next, a game machine according to a second embodiment of the invention will be described. The game machine according to the second embodiment has a display control device 70 that is different from that of the game machine according to the first embodiment in structure. In this embodiment, components not described herein have the same structure as those in the first embodiment.

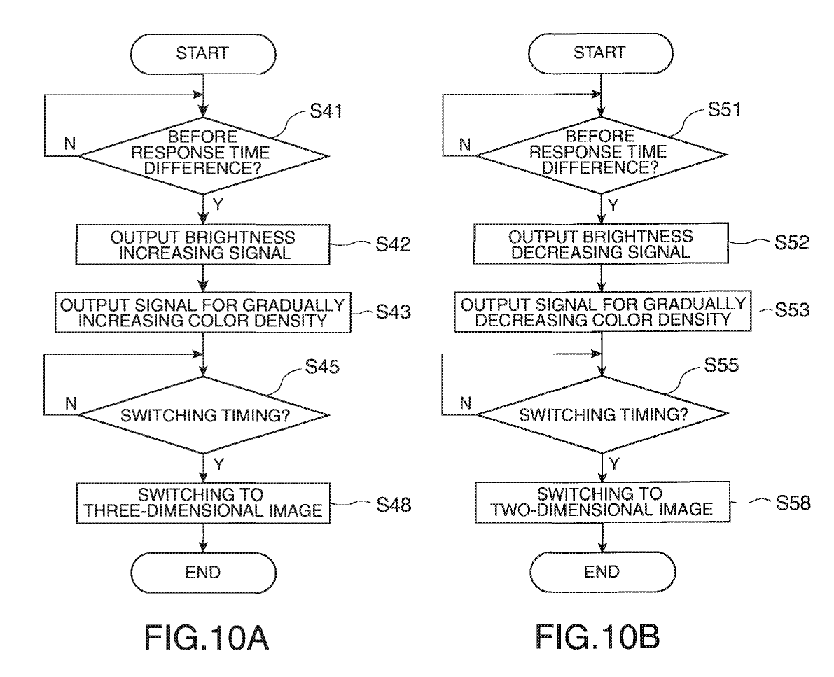

FIG. 10A is a flow chart illustrating the operation of the display control device 70 and an image display device 8. More specifically, FIG. 10A shows the control of the illuminance of illumination light when a two-dimensional image is switched to a three-dimensional image. In this case, an adjustment signal output from the CPU 71 to the illuminating device 81 leads a switching signal output from the CPU 71 to the LCD barrier 83 by a response time difference, and the switching signal output to the LCD barrier 83 gradually increases continuously or step by step. First, the image display device 8 operates in the two-dimensional image display mode. That is, the CPU 71 of the display control device 70 appropriately operates the video processor 73 with the LCD barrier 83 of the image display device 8 turned off, sequentially reads out two-dimensional image data from the CGROM 77, and controls the display panel 82 to display a two-dimensional image. At that time, when the LCD barrier 83 is turned off to improve transmittance, the illuminating device 81 is switched to the low-illuminance state, and the display panel 82 is illuminated by light with relatively low brightness. When the switching from the two-dimensional image to the three-dimensional image is performed, the CPU 71 determines whether it is as earlier as ‘response time difference’ than the display switching timing (step S41). The term ‘response time difference’ may have the same meaning as that described in the first embodiment with reference to FIG. 6. In step S41, when it is determined that the display switching timing is before the response time difference, the CPU 71 outputs to the illuminating device 81 an adjustment signal for switching the illuminating device 81 from the low-illuminance state to the high-illuminance state through the backlight driving device 87 (step S42). At the same time, the CPU 71 outputs a switching signal for gradual switching from a high-transmittance state corresponding to two-dimensional display to a low-transmittance state corresponding to three-dimensional display to the LCD barrier 83 through the LCD driving device 86 (step S43). The adjustment signal gradually increases the color density of the LCD barrier 83 from an actual transmissive state of a two-dimensional image display mode to a semi-transmissive state of a three-dimensional image display mode by giving delay time to the driving start of the LCD barrier 83 and setting appropriate operational parameters to the LCD driving device 86. Then, the CPU 71 determines whether now is the display switching timing from a two-dimensional image to a three-dimensional image (step S45). When it is determined that now is the switching timing, the CPU 71 appropriately operates the video processor 73 to sequentially read out three-dimensional image data from the CGROM 77, and controls the display panel 82 to display a three-dimensional image instead of a two-dimensional image (step S48) Then, the illuminating device 81 reaches the high-Illuminance state, and the LCD barrier 83 reaches an ON state corresponding to the maximum level of color density.

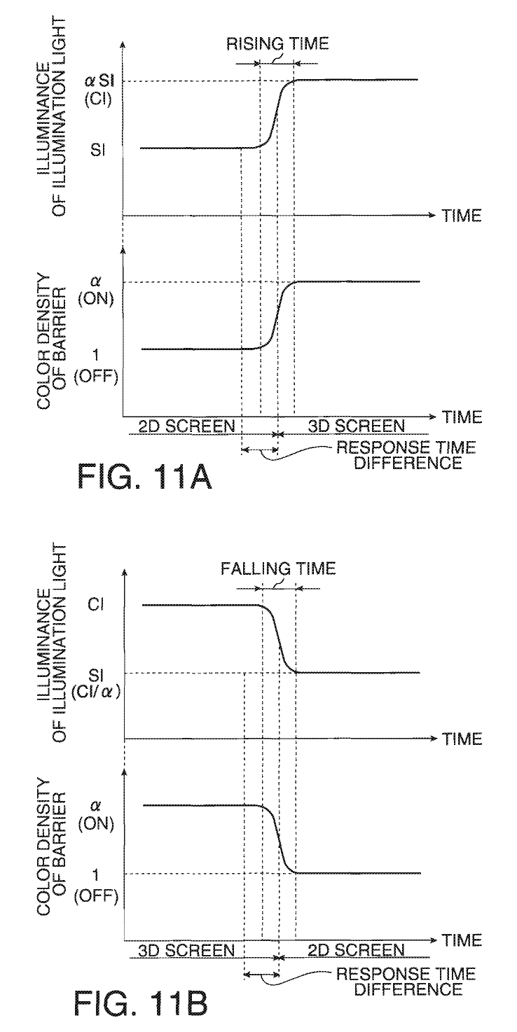

FIG. 11A is a graph illustrating the adjustment of illumination light when the two-dimensional image is switched to the three-dimensional image. As can be apparently seen from the graph, during a response period and after the response period, the illuminance of illumination light gradually increases from a low-illuminance value SI in the two-dimensional image display mode to a high-illuminance value CI in the three-dimensional image display mode. With an increase in the illuminance of illumination light, the color density of the LCD barrier 83 gradually increases from the actual transmissive state to the semi-transmissive state, similar to a variation in illuminance. As a result, the illuminance of illumination light increases α times corresponding to an increasing rate α of the color density of the LCD barrier 83 after the switching, and the brightness of the image viewed by the gamer is kept at a constant level.

FIG. 10B is a flow chart illustrating the control of the illuminance of illumination light when the three-dimensional image is switched to the two-dimensional image. First, the image display device 8 operates in the three-dimensional image display mode. That is, the CPU 71 of the display control device 70 appropriately operates the video processor 73 with the LCD barrier 83 of the image display device 8 turned on, sequentially reads out three-dimensional image data from the CGROM 77, and controls the display panel 82 to display a three-dimensional image. At that time, when the LCD barrier 83 is turned on to lower transmittance, the illuminating device 81 is switched to the high-illuminance state, and the display panel 82 is illuminated by light with relatively high brightness. When the switching from the three-dimensional image to the two-dimensional image is performed, the CPU 71 determines whether it is as earlier as ‘response time difference’ than display switching timing (step S51). The term ‘response time differences’ may have the same meaning as that described in the first embodiment with reference to FIG. 8. In step S51, when it is determined that the display switching timing is before the response time difference, the CPU 71 outputs to the illuminating device 81 an adjustment signal for switching the illuminating device 81 from the high-illuminance state to the low-illuminance state through the backlight driving device 87 (step S52). At the same time, the CPU 71 outputs a switching signal for gradual switching from the low-transmittance state corresponding to three-dimensional display to the high-transmittance state corresponding to two-dimensional display to the LCD barrier 83 through the LCD driving device 86 (step S53). The adjustment signal gradually decreases the color density of the LCD barrier 83 from the semi-transmissive state of the three-dimensional image display mode to the actual transmissive state of the two-dimensional image display mode by giving delay time to the driving start of the LCD barrier 83 and setting appropriate operational parameters to the LCD driving device 86. Then, the CPU 71 determines whether now is display switching timing from the three-dimensional image to the two-dimensional image (step S55). When it is determined that now is the display switching timing, the CPU 71 appropriately operates the video processor 73 to sequentially read out two-dimensional image data from the CGROM 77, and controls the display panel 82 to display a two-dimensional image instead of a three-dimensional image (step S58). Then, the illuminating device 81 reaches the low-illuminance state, and the LCD barrier 83 reaches an OFF state corresponding to the minimum level of color density.

FIG. 11B is a graph illustrating the adjustment of illumination light when the three-dimensional image is switched to the two-dimensional image. As can be apparently seen from the graph, during a response period and after the response period, the illuminance of illumination light gradually decreases from the high-illuminance value CI in the three-dimensional image display mode to the low-illuminance value SI in the two-dimensional image display mode. With a decrease in the illuminance of illumination light, the color density of the LCD barrier 83 gradually decreases from the semi-transmissive state to the actual transmissive state, similar to a variation in illuminance. As a result, the illuminance of illumination light decreases 1/α times corresponding to a decreasing rate 1/α of the color density of the LCD barrier 83 after the switching, and the brightness of the image viewed by the gamer is kept at a constant level.

In the second embodiment, a drop in the brightness of the illuminating device 81 corresponding to the adjustment signal of the illustrating device 81 may be a response speed that little differs from the LCD barrier 83. In this case, when the three-dimensional image display mode is switched to the two-dimensional image display mode, it is unnecessary to set the response time difference to the operation of the LCD barrier 83. In addition, it is unnecessary to gradually decrease the color density of the LCD barrier 83 from the semi-transmissive state to the actual transmissive state.

Although the embodiments of the invention have been described above, the invention is not limited to the above-described embodiments. For example, in the embodiments, a cold-cathode tube, a hot-cathode tube, or an LED is used as the lamp light source 82a. However, for example, an EL (electro-luminescent) element or an electric bulb may be used as the lamp light source 82a.

In the above-described embodiments, one of or both the lamps of the lamp light source 82a are turned on or off to adjust the illuminance of illumination light emitted from the illuminating device 81. However, it is possible to directly vary the brightness of the lamp light source 82a by changing the level of a voltage or the magnitude of a current supplied from a driving circuit of the lamp light source 82a, that is the backlight driving device 85 to the lamp light source 82a, or the duty ratio of the voltage or the current.

In the above-described embodiments, the adjustment of illumination light when the two-dimensional image is switched to the three-dimensional image has been described above, but the invention is not limited thereto. For example, the brightness of illumination light may be raised or lowered during the three-dimensional image display mode or the two-dimensional image display mode, from the viewpoint of effects or the appropriate operation of the display panel 82.

In the above-described embodiments, the display panel 82 composed of a liquid crystal display device is assembled into the image display device 8, but he invention is not limited thereto. For example, a rear-projection-type projector or other optical modulating display devices may be used instead of the liquid crystal display device.

In the above-described embodiments, the LCD barrier 83 or the display panel 82 for four viewpoints is used, but the invention is not limited thereto. For example, the design of the LCD barrier 83 may be changed to perform two-viewpoint three-dimensional display. When the two-viewpoint three-dimensional display is performed, the operation of the LCD barrier 83 causes a decreasing rate 1/α to be reduced to half thereof.

In the above-described embodiments, the image display device 8 is assembled into the game machine 2, but the invention is not limited thereto. For example, the image display device 8 or the display control device 70 may be assembled into other apparatuses (for example, a car navigation system and various household electric appliances including television games). In this case, even when the display control device 70 controls switching from a three-dimensional image to a three-dimensional image, the brightness of the image viewed by the gamer is kept at a constant level.

The entire disclosure of Japanese Patent Application No.2005-231698, filed Aug. 10, 2005 is expressly incorporated by reference herein.

What is claimed is:

1. A display device comprising:
a display unit including:
an illuminating device that emits illumination light,
a display panel that has an image display region where a two-dimensional image is formed by a light modulating device for modulating the illumination light, and
a barrier that is arranged opposite to the image display region and performs switching between an operational state in which a three-dimensional image is displayed and a non-operational state in which the three-dimensional image is not displayed; and
a control unit that adjusts illuminance of the illumination light incident on the display panel when the barrier is switched from the non-operational state to the operational state and/or when the barrier is switched from the operational state to the non-operational state.

2. The display device according to claim 1,
wherein, when the barrier is switched from the non-operational state to the operational state, the control unit increases the illuminance of the illumination light incident on the display panel.

3. The display device according to claim 1,
wherein, when the barrier is switched from the operational state to the non-operational state, the control unit decreases the illuminance of the illumination light incident on the display panel.

4. The display device according to claim 1,
wherein the illuminating device increases or decreases the illuminance of the illumination light according to an adjustment signal from the control unit,
the barrier switches the state thereof according to a switching signal from the control unit, and
the control unit sets a predetermined time interval between a first timing when the adjustment signal is output and a second timing when the switching signal is output.

5. The display device according to claim 4,
wherein the predetermined time interval is set considering at least a response characteristic of the illuminating device with respect to the switching signal, and the response characteristic varies with time.

6. The display device according to claim 1,
wherein the control unit switches the barrier from the non-operational state to the operational state step by step or continuously.

7. A game machine comprising:
the display device according to claim 1 that performs three-dimensional display in at least a portion of the image display region; and
an effect control unit that performs the three-dimensional display on the display device according to the progress of a game.

8. A method of controlling a display device, comprising:
switching a barrier that is arranged opposite to an image display region where a two-dimensional image is formed by a light modulating device for modulating illumination light between an operational state in which a three-dimensional image is displayed and a non-operational state in which the three-dimensional image is not displayed, an image display region; and
adjusting illuminance of the illumination light incident on a display panel when the barrier is switched from the non-operational state to the operational state and/or when the barrier is switched from the operational state to the non-operational state.

9. A method of controlling the display device according to claim 1.
